(19) United States
(12) Patent Application Publication
(10) Pub. No.: US 2019/0141417 A1
(43) Pub. Date: May 9, 2019

(54) Method for Transmitting a Value Measured by a Sensor, Method for Receiving the Measured Value, Sensor, Control Device

(71) Applicant: Robert Bosch GmbH, Stuttgart (DE)

(72) Inventors: Marlon Ramon EWERT, Untergruppenbach (DE); Daniel SCHOENFELD, Abstatt (DE)

(21) Appl. No.: 16/073,276

(22) PCT Filed: Dec. 22, 2016
(86) PCT No.: PCT/EP2016/082370

§ 371 Date: Dec. 19, 2018

(30) Foreign Application Priority Data
Jan. 29, 2016 (DE) 10 2016 201 419.6

(51) Int. Cl. H04Q 9/00

(52) U.S. Cl. CPC H04Q 9/00

(57) ABSTRACT

A method for transmitting a value measured by a sensor includes transmitting the measured value by a first data word and a second data word. The first data word represents the measured value at a first resolution, and the second data word represents the measured value at a second resolution.

The present invention relates to a method for transmitting a value measured by a sensor, a corresponding method for receiving the measured value, and a sensor and a control device as claimed in the independent claims.

### PRIOR ART

A method for digital transmission from a sensor to a control device is known from DE 101 49 332 A1, in which the sensor values of the sensor are divided with different resolutions for the data transmission. The sensor values form a first range of values with sequential sensor values. The division of the first range of values for the data transmission is made depending on a value relevant for the control device.

PSI5 is an open standard, and supports the querying of up to four sensors per bus node, which can be queried in different configurations. A bidirectional communication for sensor configuration and diagnosis is also provided.

In airbag systems, data from, for example, pressure or acceleration sensors is evaluated over current-modulated two-wire buses which communicate with the control device using a Manchester-encoded protocol.

The possible operating modes are also specified in the standard. These are initially differentiated into synchronous and asynchronous operating modes. In the synchronous operating modes, these three operating modes emerge, depending on the interconnection of the sensors with the control unit: parallel bus mode (all sensors are connected in parallel), universal bus mode (serial interconnection of the sensors) and daisy chain bus mode. Combined with other parameters such as the total number of timeslots, data rate, data word length, parity/CRC monitoring, the PSI5 standard allows for various possible realizations. The use of the 10-bit data word length is widespread.

As a rule, PSI5 sensors used nowadays use a resolution with a fixed definition for the measured value of a sensor channel on a single communication slot. This resolution, with its fixed definition, is usually constant over the entire acquisition range of the sensor.

A disadvantage of the practice to date is the compromise that is necessary between a high measured value resolution and a wide measuring range. A 10-bit sensor today, for example, either supports a high resolution with a low measuring range or a wide measuring range with low resolution. This is above all counter-productive when one and the same sensor is used for different applications, where the measurement ranges and resolutions for the different applications fundamentally differ and are thus not compatible with one another. This can above all have a negative effect on the configuration of algorithms (such as, for example, algorithms for triggering restraining means in airbag control devices).

### DISCLOSURE OF THE INVENTION

Against this background, a method is proposed with the present invention for transmitting measured values in which a measured value is transmitted by means of a first and a second data word, wherein the first data word represents the measured value with a first resolution and the second data word represents the measured value with a second resolution.

The important advantage of the invention is that one and the same sensor value is transmitted as sensor signals in data words with different resolutions. The advantage here manifests primarily in the receiver of the transmission, since corresponding applications can run with the corresponding resolutions and ranges of values of one and the same sensor value. The data words or sensor signals received in the receiver represent one and the same value. The values can thus be considered simultaneous in the receiver.

Both high-resolution signals with a small range of values and low-resolution signals with a large range of values can be transmitted in this way from one and the same sensor.

According to one form of embodiment of the method of the present invention, the first and the second data words have the same word length.

A word length of 10 bits in particular has become established in the field of automotive applications.

In an advantageous form of embodiment of the method of the present invention, the first resolution is not equal to the second resolution.

In this way applications with different requirements for the resolution and, consequentially, in the possible range of values at the measured value, can make use of one and the same sensor in a simple manner.

The variant of the method of the present invention according to which the first resolution is higher than the second resolution is of particular significance here.

In an advantageous variant of the method of the present invention, the measured value is mapped onto the first data word by means of the first function or a case distinction, and mapped onto the second data word by means of a second function or a case distinction.

The form of embodiment of mapping the measured value by means of the function or mathematical function in particular offers the advantage that the mapping of the measured value onto the data words can be automated. The automation is either carried out by means of a suitable software or of a suitably designed, application-specific integrated circuit (ASIC).

It is of particular significance here if the first function and/or the second function is at least an injective, or better a bijective function.

An inverse function thus exists for the function used, and can be used at the receiver side in order to obtain the mapped measured value from the transmitted data words.

In a further advantageous variant of the method of the present invention, the first and second data words are transmitted by means of the PSI5 protocol, wherein the first and the second data words are transmitted in different communication slots, in particular in immediately sequential communication slots.

In an alternative form of embodiment of the method, the data words can also be transmitted in alternation in the same communication slot. Equally it would be conceivable for the data words to be transmitted within one and the same communication slot, for example one after another.

In the present case, a communication slot primarily refers to a period of time within one transmission cycle. In a topology in which a plurality of sensors are connected to a bus line of a receiver, a transmission cycle refers to the time in which it was at least once the turn of each sensor to transmit at least one data word.

The PSI5 protocol has, for example, communication slots within which data are transmitted. Through the inclusion of a further second communication slot for the transmission of the second data word, different from the first communication slot, the present invention can easily be implemented in the framework of the existing standards without great effort. This represents an economical and easy implementation of this variant of the method of the present invention.

A further aspect of the present invention is a method for receiving a measured value in which the measured value is received by means of a first and a second data word, wherein the first data word represents the measured value with a first resolution and the second data word represents the measured value with a second resolution.

According to an advantageous variant of the method for receiving, the data words according to a form of embodiment of the method for transmitting a measured value are transmitted according to the present invention.

It is of particular significance then that the measured value is formed by means of the third function or a third case distinction from the first data word, and is formed by means of a fourth function or of a fourth case distinction from the second data word, wherein the third function is the inverse function of the first function and the fourth function is the inverse function of the second function.

Through this variant of the method for receiving a measured value according to the present invention, the transmission of the sensor signals can be performed reliably and easily with the required resolutions and ranges of values for the different applications.

A further aspect of the present invention is a sensor that is designed in such a way that the sensor carries out all the steps of a form of embodiment of the method for transmitting the measured value according to the present invention.

According to a special variant of this form of embodiment, in an initialization phase the sensor transmits the first and/or second function and/or the first and/or second case distinction of the stored functions and/or case distinctions selected for mapping.

According to this variant, the use of the sensor of the present invention is significantly simplified. Depending on the type of application, wherein the type of application refers to the type of sensor (pressure or inertial sensor), the place of use (upfront sensor, side impact sensor, . . . ), the application type (crash detection, crash plausibility checking, pedestrian impact detection), a corresponding stored function can be selected, which is transmitted during the initialization. Instead of the function itself, or of its mathematical representation, it is also conceivable that a value is transmitted that uniquely identifies the selected function for the receiver.

A further aspect of the present invention is a method for the manufacture of a sensor according to the present invention, in which the third function or the third case distinction and the fourth function or the fourth case distinction are stored in the sensor during manufacture.

It is advantageous with this method of manufacture, that the sensor is ready for use immediately after manufacture, without the need for a configuration or adjustment of the sensor to be carried out prior to application or installation.

In this manufacturing method all the relevant functions for the mapping are stored in the sensor during the manufacturing process.

It would also be conceivable for the stored functions to be appropriately protected, or to be stored in signed form in the sensor, so that a subsequent manipulation or modification is not possible, or at least that it does not remain undetected.

A control device that is designed in such a way that the control device carries out all the steps of a form of embodiment of the method for receiving the measured value according to the present invention is also an aspect of the present invention.

Forms of embodiment of the present invention are represented with reference to figures and explained below. Here:

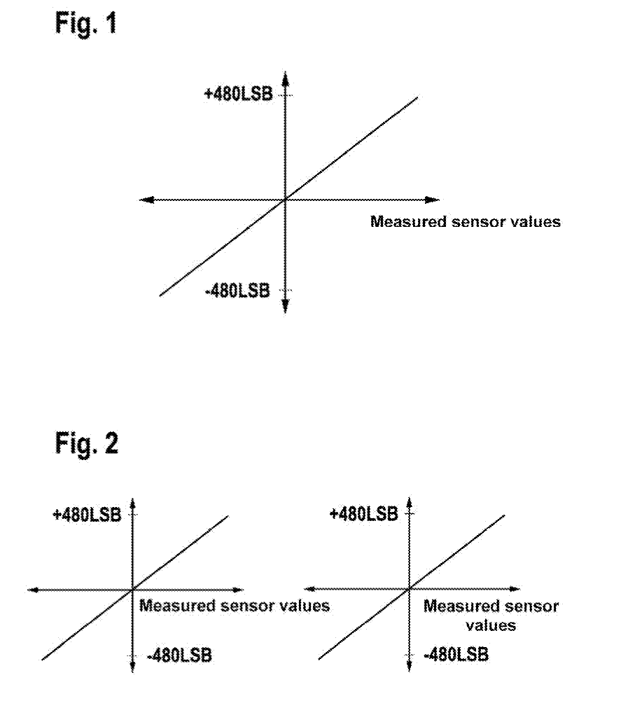

FIG. 1 shows a linear mapping of measured sensor values onto sensor signals of a communication bus according to today's prior art;

FIG. 2 shows mappings of measured sensor values onto data words at two different communication slots for transmission according to the present invention;

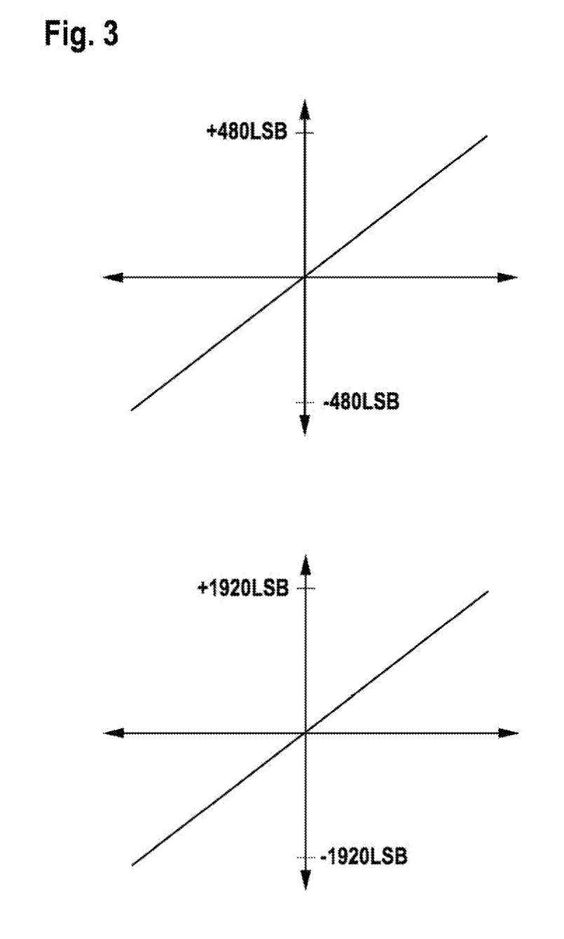

FIG. 3 shows mapping of sensor signals onto measured sensor values after reception according to the present invention;

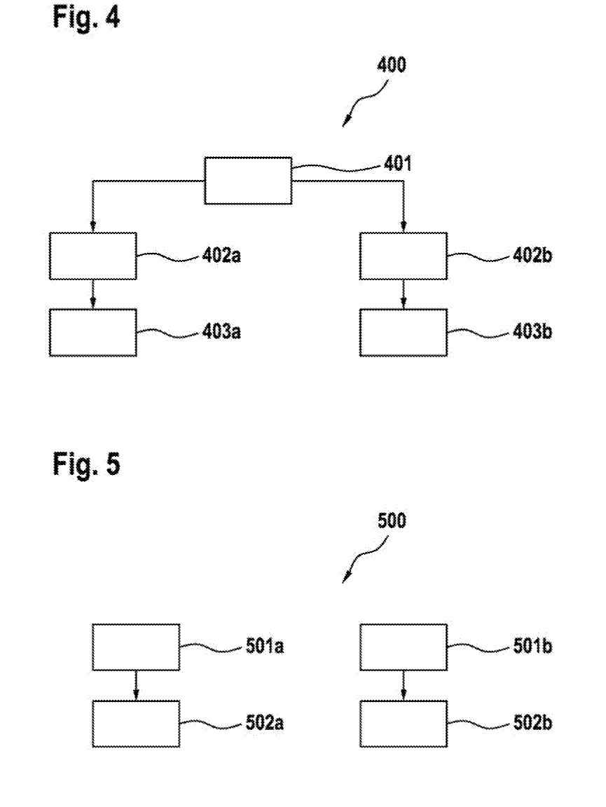

FIG. 4 shows a flow diagram of a form of embodiment of the method for transmitting a measured value according to the present invention;

FIG. 5 shows a flow diagram of a form of embodiment of the method for receiving a measured value according to the present invention.

FIG. 1 shows a linear mapping of measured sensor values onto sensor signals of a communication bus according to the prior art. The data range of a 10-bit sensor for a sensor channel according to FIG. 1 is here formed linearly from the measured sensor values from −480 LSB up to +480 LSB.

The measured sensor values are plotted on the abscissa. The values of the data word are plotted on the ordinate. The red line here represents the linear assignment of the range of measured sensor values to the data word range of +/−480 LSB.

FIG. 2 shows mappings of measured sensor values onto data words at two different communication slots for transmission according to one variant of the method of the present invention.

Here again the measured sensor values are plotted on the abscissa. And the values of the data word are plotted on the ordinate. The red line represents the assignment of the range of measured sensor values to the data word range of +/−480 LSB.

In the mappings illustrated, however, the measured sensor value is mapped with a first resolution onto the data word range from +/−480 LSB, and with a second resolution, onto the same data word range, from +/−480 LSB.

According to the illustration in FIG. 2, the measured sensor values of the sensor are first transmitted up to a range from +/−480 LSB with a first resolution on the first communication slot of a communication bus. The transmission of the measured sensor values then takes place in at least one further communication slot of the same communication bus, with a second resolution. The resolutions of the data word ranges on the two communication slots here are different. A scaling of the measured sensor values with the required resolution to the range of values from +/−480 LSB however takes place before the measured sensor values are transmitted on the individual slots.

FIG. 3 shows a mapping of sensor signals onto measured sensor values after the reception according to one variant of the method of the present invention.

The “back-calculation” takes place, for example, in a control device according to the present invention, at which a sensor according to the present invention transmits connected measured values. In the example illustrated in FIG. 3, the first resolution of the measured sensor values on the first communication slot corresponds to 1 LSB/measured sensor value, and the second resolution of the measured sensor values on the second communication slot to 0.25 LSB/measured sensor value.

It can thus be seen from the illustration of FIG. 3, that through the back-calculation of the measured sensor values from the sensor signals out of the two communications slots in the control device, measured sensor values arise with different resolutions and with different ranges of values.

The measured sensor values with 1 LSB/measured sensor value are transmitted on the communication bus on the first communication slot. As a result, after back-calculation, high-resolution measured sensor values with a resolution of 1 measured sensor value/LSB therefore result, where the range of values extends over +/−480 LSB measured sensor values.

The measured sensor values with 0.25 LSB/measured sensor value are transmitted on the communication bus on the second communication slot. As a result, after back-calculation, low-resolution measured sensor values with a resolution of 4 measured sensor values/LSB therefore result, where the range of values extends over +/−1920 LSB measured sensor values.

The range of measured values of +/−1920 LSB transmitted over the communication interface on the second communication slot is thus in this example larger by a factor of 4 than the range of values of +/−480 LSB transmitted on the first communication slot.

These signals with different resolutions in the two slots can then be used in a further step within one or more algorithms on the control device for different applications.

For example, the high-resolution signals of the first communication slot are used in an algorithm for which the high resolution of the signals is more important than a high range of values.

On the other hand, the low-resolution signals of the second communication slot are used in an algorithm for which the resolution of the signals only plays a subsidiary role, while at the same time a high range of values is required.

FIG. 4 shows a flow diagram of a form of embodiment of the method for transmitting a measured value according to the present invention.

A measured value is acquired in step 401. This measured value is mapped in step 402a for transmission with a first resolution onto a first data word, and in step 402b mapped onto a second data word with a second resolution.

The first data word is transmitted in step 403a in a first communication slot over a communication bus.

The second data word is transmitted in step 403b in a second communication slot over the same communication bus.

FIG. 5 shows a flow diagram of a form of embodiment of the method for receiving a measured value according to the present invention.

In step 501a a first data word is received in a first communication slot over a communication bus. In step 501b a second data word is transmitted in a second communication slot over the same communication bus.

The first and the second data words here represent the same measured value by means of a first and a second resolution.

In step 502a, the measured value according to the first resolution represented by the first data word is back-calculated, and is then made available to an application.

In step 502b, the measured value according to the second resolution represented by the first data word is back-calculated, and is then made available to an application.

1. A method for transmitting a measured value measured by a sensor, comprising:
generating a first data word representing the measured value at a first resolution;
generating a second data word representing the measured value at a second resolution; and
transmitting the measured value by transmitting the first data word and the second data word.

2. The method as claimed in claim 1, wherein the first and the second data words have the same word length.

3. The method as claimed in claim 1, wherein the first resolution is not equal to the second resolution.

4. The method as claimed in claim 1, further comprising:
mapping the measured value onto the first data word based on a first function or a first case distinction; and
mapping the measured value onto the second data word based on a second function or a second case distinction,
wherein the first function and/or the second function is an injective and/or a bijective function.

5. The method as claimed in claim 1, further comprising:
transmitting the first and second data words according to a communication protocol, the communication protocol having at least one communication slot for transmission; and
transmitting the first and the second data words in different communication slots, or in sequence within the same communication slot, or alternating within the same communication slot.

6. A method for receiving a measured value measured by a sensor, comprising:
representing the measured value at a first resolution with a first data word;
representing the measured value at a second resolution with a second data word; and
receiving the measured value by receiving the first data word and the second data word.

7. The method as claimed in claim 6, wherein the first and the second data words have the same word length.

8. The method as claimed in claim 6, wherein the first resolution is not equal to the second resolution.

9. The method as claimed in claim 6, further comprising:
receiving the first and second data words according to a communication protocol, the communication protocol having at least one transmission channel and at least one communication slot for receiving; and
receiving the first and the second data words from different communication slots, or in sequence from the same communication slot, or alternating from the same communication slot.

10. The method as claimed in claim 6, wherein the measured value is transmitted by transmitting the first data word and the second data word.

11. The method as claimed in claim 10, further comprising:
forming the measured value based on a third function or a third case distinction from the first data word, and further based on a fourth function or of a fourth case distinction from the second data word,
wherein the third function is an inverse function of a first function used to form to the first data word, and
wherein the fourth function is an inverse function of a second function used to form the second data word.

12. The method as claimed in claim 11, wherein a sensor is configured to carry out the method.

13. The method as claimed in claim 12, wherein the first function or the first case distinction and the second function or the second case distinction are stored in the sensor for mapping the measured values onto the first and the second data words.

14. The method as claimed in claim 13, wherein the sensor, in an initialization phase, transmits the first and second function and/or first and second case distinctions of the stored functions and/or case distinctions selected for mapping.

15. The method as claimed in claim 12, wherein the third function or the third case distinction and the fourth function or the fourth case distinction are stored in the sensor during manufacture.

16. The method as claimed in claim 6, wherein a control device is configured to carry out the method.

17. The method as claimed in claim 1, wherein a computer program is configured to carry out the method.

18. The method as claimed in claim 17, wherein the computer program is stored on a machine-readable storage medium.
